(19) United States
(12) Patent Application Publication
(10) Pub. No.: US 2016/0326306 A1
(43) Pub. Date: Nov. 10, 2016

(54) POLYESTER HYDROGELS

(71) Applicant: BASF SE, Ludwigshafen (DE)

(72) Inventors: Motonori YAMAMOTO, Mannheim (DE); Alexander WISSEMEIER, Speyer (DE); Wolfgang WEIGELT, Dudenhofen (DE); Harald KELLER, Ludwigshafen (DE); Michael SEUFERT, Bad Duerkheim (DE); Gimmy Alex FERNANDEZ RAMIREZ, Ludwigshafen (DE); Jorge SANZ-GOMEZ, Heidelberg (DE); Alexandra WIEDEMANN, Weisenheim am Berg (DE)

(73) Assignee: BASF SE, Ludwigshafen (DE)

(21) Appl. No.: 15/104,408

(22) PCT Filed: Dec. 17, 2014
(86) PCT No.: PCT/EP2014/078207

§ 371 Date: Jun. 14, 2016

(30) Foreign Application Priority Data
Dec. 19, 2013 (EP) 13198671.3

(51) Int. Cl. C08G 63/676; C05G 3/04; C05G 3/00; C08G 63/91; C09K 17/18

(52) U.S. Cl. CPC C08G 63/676; C08G 63/916; C09K 17/18; C05G 3/0047; C05G 3/04; C08G 2230/00; C08G 2210/00

(57) ABSTRACT

Cross-linked polyester derived from unsaturated polyester chains, which are inter-molecularly cross-linked and comprise units derived from unsaturated dicarboxylic acid based monomers and ethylene glycol based monomers.

### FIELD OF THE INVENTION

The present invention relates to a cross-linked polyester derived from unsaturated polyester chains, which are inter-molecularly cross-linked and comprise units derived from groups of monomers A and B, wherein (a) the group of monomers A consists of (a1) monomers A1, or (a2) monomers A1 and monomers A2, with monomers A1 and monomers A2 being present in a molar ratio of at least 4:1, wherein the monomers A1 are selected from the group consisting of unsaturated dicarboxylic acid based monomers of general formula (I) and mixtures thereof, and wherein the monomers A2 are selected from the group consisting of dicarboxylic acid based monomers of general formula (II) and mixtures thereof, and wherein (b) the group of monomers B consists of (b1) monomers B1, (b2) monomers B2, or (b3) monomers B1 and B2, wherein the monomers B1 are selected from the group consisting of ethylene glycol based monomers of general formula (III) and mixtures thereof, and wherein the monomers B2 are selected from the group consisting of propylene glycol based monomers of general formula (IV) and mixtures thereof; wherein the molar ratio of the units derived from the group of monomers A to the units derived from the group of monomers B is from 1.3:1 to 1:1.3 in the unsaturated polyester chains. The present invention further relates to a composition comprising as compounds the cross-linked polyester of the invention and saw dust; to an absorbent material comprising the cross-linked polyester or the composition of the invention; and to a soil treatment product comprising the cross-linked polyester or the composition of the invention, and at least one additional compound selected from the group consisting of fillers, nutrients, fertilizers, pesticides and combinations thereof. Furthermore, the present invention relates to the use of the cross-linked polyester or the composition of the invention for agricultural applications.

### BACKGROUND OF THE INVENTION

Hydrogels are formed from superabsorbent polymers which can absorb and retain extremely large amounts of a liquid relative to their own mass. Such superabsorbent polymers are often also referred to as swellable polymers, hydrogel forming polymers, water absorbing polymers, gelforming polymers, and the like. Sometimes also the superabsorbent polymer in the dry form is referred to as hydrogel. In the context of the present invention, the term “hydrogel” will be used only in the context of the wetted state of a superabsorbent polymer, however, because in the dry state, the superabsorbent polymer is typically not present in the form of a gel, but in the form of a powder or a granulate having good flow properties.

An overview over superabsorbent polymers, their properties and methods of manufacturing them is provided by Frederic L. Buchholz and Andrew T. Graham in “Modern Superabsobent Polymer Technology”, J. Wiley & Sons, New York, USA/Wiley VCH, Weinheim, Germany, 1997, ISBN 0-471-19411-5.

Superabsorbent polymers and compositions comprising superabsorbent polymers have become an important material for agricultural applications due to their capacity of absorbing large quantities of water. By using the superabsorbent polymers and superabsorbent compositions for soil treatment, the physiological properties of soils can be improved by increasing their capacity to hold water, reducing erosion and runoff, reducing the frequency of irrigation, increasing the efficiency of the water being used, increasing soil permeability and infiltration, reducing the tendency of the soil to get compacted, and helping plant performance.

Most of the superabsorbent polymers used today are cross-linked synthetic polymers. They include, for example, polymers and copolymers based on acrylamide, which are not based on renewable raw materials and which are insufficiently biodegradable.

For many applications, and in particular for agricultural applications, the biodegradation of the superabsorbent polymers is a preferred or required design variable to be addressed, however. In this context, polyester-based superabsorbent polymers are considered highly attractive not only because of their biodegradability, but also because of the large availability of the monomers, which may inter alia be, for example, polyethylene glycol and maleic anhydride.

Polyesters are typically formed by reacting dicarboxylic acid based monomers with diol monomers. As superabsorbent polymers, cross-linked polyesters obtainable from unsaturated polyesters are particularly preferred. Said unsaturated polyesters are typically based on unsaturated dicarboxylic acid based monomers and diol monomers. Unsaturated dicarboxylic acid based monomers such as maleic anhydride are particularly useful for the preparation of polyester-based superabsorbent polymers because the double bonds contained therein can easily be cross-linked, in order to obtain a three-dimensional network of polyester chains, which exhibits a good swellability.

In this context, Temenoff et al. describe oligo(polyethylene glycol)fumarate hydrogels for cartilage tissue engineering (Temenoff et al., OPF Hydrogel Material Properties 2002, 429-437). The hydrogels are obtained by cross-linking oligo(polyethylene glycol)fumarate with poly(ethylene glycol)diacrylate.

Furthermore, Tong et al. describe an unsaturated polyester based on poly(ethylene glycol), which is prepared by one-stage melt condensation of maleic anhydride, phthalic anhydride, propylene glycol, and poly(ethylene glycol)s (Tong et al., Polymer Engineering and Science 1985, 25, 54-56). In this context, castings from styrenated resins are mentioned, which indicates that the unsaturated polyester is cross-linked by reacting it with styrene.

Moreover, WO 2008/008288 A2 discloses charged oligo(poly(ethylene glycol)fumarate) hydrogels in the context of a biodegradable material for improving the regeneration of nerve cells. The hydrogels are obtained by cross-linking oligo(poly(ethylene glycol)fumarate) with a charged reactant, which may e.g. be an unsaturated quaternary ammonium compound.

It is noted that the cross-linked polyesters in the above prior art references are obtained by cross-linking an unsaturated polyester with an additional unsaturated reactant or cross-linking agent, but not by inter-molecularly cross-linking the unsaturated polyester chains directly via the double bonds contained therein, i.e. in the absence of an unsaturated reactant or cross-linking agent.

Furthermore, the prior art references do not disclose that the described cross-linked polyesters may be used for agricultural applications, e.g. for soil treatment.

It should be noted that the use of an additional unsaturated reactant or cross-linking agent for cross-linking an unsaturated polyester may significantly influence the properties of the resulting cross-linked polyester, e.g. in terms of the stickiness and the swellability.

A low stickiness is advantageous because the cross-linked polyesters can then be provided in the form of a granulate or powder having good flow properties.

The swellability is of particular relevance for the use of the cross-linked polyester for agricultural applications, e.g. for soil treatment, because a high water absorption capacity is essential for this purpose.

With regard to the swellability, it is further noted that the swellability is typically also correlated with the cross-link density of the cross-linked polyester. A low cross-link density is advantageous for the swellability, whereas a high cross-link density is disadvantageous.

Accordingly, it is desired to provide a cross-linked polyester, which is cross-linked as such that a low stickiness and a high swellability is achieved. Furthermore, said cross-linked polyester should have a rather low cross-link density, which is further advantageous in terms of the swellability.

In particular, there is a need for cross-linked polyesters, which exhibit a high water absorption capacity, a low stickiness, and good flowability properties, if provided e.g. in granular form. In this context, it is also of particular interest that the cross-linked polyesters are derived from unsaturated polyesters, which comprise units derived from readily available, inexpensive monomers, and which are easily to be manufactured.

It is therefore the object of the present invention to provide such cross-linked polyesters, which are advantageous over the prior art in terms of the water absorption capacity, the stickiness and the flowability, and which are at the same time obtainable by readily available, inexpensive monomers, preferably by a simple manufacturing process.

Furthermore, it is an object of the present invention to provide a composition comprising a cross-linked polyester, which not only exhibits a high water absorption capacity, but also good flowability properties. In this context, it is particularly desired that the composition comprises a further component, which can improve the water absorption capacity and the flowability of the polyester alone, and which is inexpensively available.

Furthermore, it is an object of the present invention to provide an absorbent material and a soil treatment product, which exhibit a high water absorption capacity.

### SUMMARY OF THE INVENTION

The above mentioned objects are achieved by providing a cross-linked polyester derived from unsaturated polyester chains, which are inter-molecularly cross-linked and comprise units derived from groups of monomers A and B,

wherein
(a) the group of monomers A consists of
(a1)) monomers A1, or
(a2) monomers A1 and monomers A2, with monomers A1 and monomers A2 being present in a molar ratio of at least 4:1,
wherein the monomers A1 are selected from the group consisting of unsaturated dicarboxylic acid based monomers of the following general formula (I)

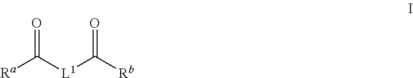

wherein
L¹ represents a linear or branched C₂-C₈-alkylene chain, and
   (i) R^{a} and R^{b} are independently selected from -halo, —OH, —OR¹, —NH₂ and —N(R¹)₂ with R¹ being —(C₁-C₆)alkyl or —C(═O)(C₁-C₄)alkyl, or
   (ii) R^{a}-R^{b} together represent an oxygen bridge —O—,
and mixtures thereof, and
wherein the monomers A2 are selected from the group consisting of dicarboxylic acid based monomers of the following general formula (II)

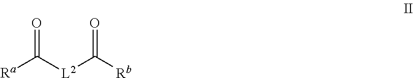

wherein
L² represents a linear or branched C₁-C₁₈-alkyl chain or a benzene ring, and
   (i) R^{a} and R^{b} are independently selected from -halo, —OH, —OR¹, —NH₂ and —N(R¹)₂ with R¹ being —(C₁-C₆)alkyl or —C(═O)(C₁-C₄)alkyl, or
   (ii) R^{a}-R^{b} together represent an oxygen bridge —O—,
and mixtures thereof,
   (b) the group of monomers B consists of
(b1) monomers B1,
(b2) monomers B2, or
(b3) monomers B1 and B2,
wherein the monomers B1 are selected from the group consisting of ethylene glycol based monomers of the following general formula (III)

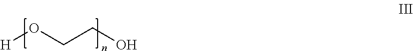

wherein n is an integer of from 1 to 300,
and mixtures thereof, and
wherein the monomers B2 are selected from the group consisting of propylene glycol based monomers of the following general formula (IV)

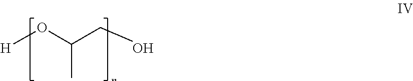

wherein n is 1, 2, 3, 4, 5 or 6,
and mixtures thereof;
   wherein the molar ratio of the units derived from the group of monomers A to the units derived from the group of monomers B is from 1.3:1 to 1:1.3 in the unsaturated polyester chains.

Preferably, the group of monomers B consists of monomer B1.

It has surprisingly been found that cross-linked polyesters derived from unsaturated polyester chains, which are inter-molecularly cross-linked and which comprise units derived from groups of monomers A and B as defined above, exhibit advantageous properties in terms of the water absorption capacity, the stickiness and the flowability, and are at the same time obtainable by readily available, inexpensive monomers. Furthermore, the cross-linked polyesters are easily to be manufactured because the unsaturated polyester chains can be formed from only two groups of monomers A and B, and cross-linking of the unsaturated polyester chains can be achieved without the addition of a cross-linking agent.

Moreover, it is noted that the cross-linked polyesters according to the invention accelerate plant growth significantly, if used for agricultural applications.

Accordingly, the present invention provides a cross-linked polyester, which may be used as an inexpensive and effective product for agricultural applications. In this context, it is also emphasized that the cross-linked polyesters of the invention are biodegradable and therefore particularly suitable for soil treatment.

The invention further relates to a composition comprising as compounds the cross-linked polyester of the invention and saw dust or flax dust or a combination thereof. Preferably, the saw dust or flax dust is embedded in the three-dimensional network of the cross-linked polyester. As a consequence, the water absorption capacity and the water retention capacity as well as the flowability properties are improved. The improved water absorption capacity may e.g. result in an improved plant growth.

Furthermore, the invention relates to an absorbent material comprising the cross-linked polyester according to the present invention or the composition according to the present invention. Said absorbent material exhibits particularly advantageous water absorption properties.

Moreover, the present invention relates to a soil treatment product comprising the cross-linked polyester according to the present invention or the composition according to the present invention, and at least one additional compound selected from the group consisting of fillers, nutrients, fertilizers, pesticides and combinations thereof.

The present invention also relates to the use of the cross-linked polyesters of the invention or the compositions of the invention for agricultural applications, preferably for improving the physiological properties of soils, more preferably for absorbing and storing humidity in soils, and/or for improving the soil structure by loosening the soil. In this context, it has surprisingly been found that plant growth is accelerated by at least 20%, preferably at least 30%, more preferably at least 40%.

### DETAILED DESCRIPTION OF THE INVENTION

The cross-linked polyester of the present invention is derived from unsaturated polyester chains, which are inter-molecularly cross-linked and comprise units derived from groups of monomers A and B,

wherein
(a) the group of monomers A consists of
(a1) monomers A1, or
(a2) monomers A1 and monomers A2, with monomers A1 and monomers A2 being present in a molar ratio of at least 4:1,
wherein the monomers A1 are selected from the group consisting of unsaturated dicarboxylic acid based monomers of the following general formula (I)

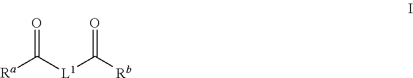

wherein
L¹ represents a linear or branched C₂-C₈-alkylene chain, and
   (i) R^{a} and R^{b} are independently selected from -halo, —OH, —OR¹, —NH₂ and —N(R¹)₂ with R¹ being —(C₁-C₆)alkyl or —C(═O)(C₁-C₄)alkyl, or
   (ii) R^{a}-R^{b} together represent an oxygen bridge —O—,
and mixtures thereof, and
wherein the monomers A2 are selected from the group consisting of dicarboxylic acid based monomers of the following general formula (II)

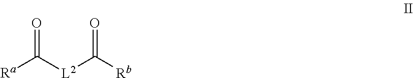

wherein
L² represents a linear or branched C₁-C₁₈-alkyl chain or a benzene ring, and
   (i) R^{a} and R^{b} are independently selected from -halo, —OH, —OR¹, —NH₂ and —N(R¹)₂ with R¹ being —(C₁-C₆)alkyl or —C(═O)(C₁-C₄)alkyl, or
   (ii) R^{a}-R^{b} together represent an oxygen bridge —O—,
and mixtures thereof,
   (b) the group of monomers B consists of
(b1) monomers B1,
(b2) monomers B2, or
(b3) monomers B1 and B2,
wherein the monomers B1 are selected from the group consisting of ethylene glycol based monomers of the following general formula (III)

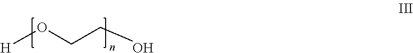

wherein n is an integer of from 1 to 300,
and mixtures thereof, and
wherein the monomers B2 are selected from the group consisting of propylene glycol based monomers of the following general formula (IV)

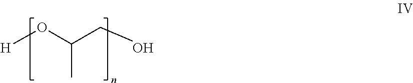

wherein n is 1, 2, 3, 4, 5 or 6,
and mixtures thereof;
   wherein the molar ratio of the units derived from the group of monomers A to the units derived from the group of monomers B is from 1.3:1 to 1:1.3 in the unsaturated polyester chains.

With regard to the molar ratio of the units derived from the group of monomers A to the units derived from the group of monomers B in the unsaturated polyester chains, it is preferred that said molar ratio is from 1.2:1 to 1:1.2, more preferably from 1.1:1 to 1:1.1, most preferably about 1:1.

The terms “polyethylene glycol monomers” and “ethylene glycol based monomers” are used synonymously. The terms “polypropylene glycol monomers” and “propylene glycol based monomers” are used synonymously.

In this context, the term “molar ratio” is to be understood as the ratio of the amounts of the units in mol % based on the complete polyester chain. In this context, it should be noted that it is typically assumed in the art that the complete polyester chain is represented by 200 mol %, wherein about 100 mol % are represented by the units derived from dicarboxylic acid based monomers and about 100 mol % are represented by the units derived from diol based monomers, provided that no further units are present in the polyester chain. This corresponds to a molar ratio of the units derived from dicarboxylic acid based monomers to units derived from diol based monomers of about 1:1. The same can be applied to the unsaturated polyester chains of the present invention. According to the present invention, the molar ratio of the units derived from the group of monomers A to the units derived from the group of monomers B may vary between 1.3:1 to 1:1.3, preferably from 1.2:1 to 1:1.2, more preferably from 1.1:1 to 1:1.1, most preferably about 1:1 in the unsaturated polyester chains. Accordingly, the units derived from the group of monomers A may e.g. be present in an amount of from 113 mol % to 87 mol %, and the units derived from the groups of monomers B may e.g. be present in an amount of from 87 mol % to 113 mol % at the same time, so that the sum of the mol % values is preferably about 200 mol %, provided that no other units are present in the polyester chain. Preferably the units derived from the group of monomers A are present in an amount of about 100 mol % and the units derived from the group of monomers B are also present in an amount of about 100 mol % based on the complete unsaturated polyester chain represented by 200 mol %. If the units derived from the groups of monomers A and B are both present in an amount of 100 mol %, the molar ratio of the units derived from the group of monomers A to the units derived from the group of monomers B is 1:1.

In a preferred embodiment, the cross-linked polyester of the present invention may not only comprise the above described units derived from the groups of monomers A and B, but also alternative units or additives in an amount of at most 10 wt.-%, preferably at most 5 wt.-%, more preferably at most 1 wt.-%.

In another preferred embodiment, the units derived from the groups of monomers A and B are together present in an amount of at least 85 wt.-%, preferably at least 90 wt.-%, more preferably at least 93 wt.-%, most preferably at least 95 wt.-%, particularly preferably at least 97 wt.-%, particularly at least 99 wt.-% based on the total weight of the cross-linked polyester.

Thus, it is preferred that the cross-linked polyester is exclusively derived from unsaturated polyester chains, which comprise at least 90 wt.-%, preferably at least 95 wt.-%, more preferably at least 99 wt.-% of units derived from the groups of monomers A and B based on the total weight of the unsaturated polyester chains.

Preferably, the cross-linked polyester does not comprise units derived from aromatic sulfonated dicarboxylic acid based monomers, such as 5-sulfoisophthalic acid based monomers, alkali salts thereof and mixtures thereof. In particular, it is preferred that the cross-linked polyester does not comprise units derived from 5-sulfoisophthalic acid sodium salt monomers.

Particularly preferably, the cross-linked polyester of the present invention is exclusively derived from unsaturated polyester chains, which consist of units derived from the groups of monomers A and B. In this context, it is also preferred that the group of monomers A consists of monomers A1 and that the group of monomers B consists of group of monomers B1.

According to the present invention, the group of monomers A consists of

(a1) monomers A1, or
(a2) monomers A1 and monomers A2, with monomers A1 and monomers A2 being present in a molar ratio of at least 4:1.

Thus, the group of monomers A may either comprise exclusively the monomers A1 or the monomers A1 in combination with monomers A2, wherein the monomers A1 and the monomers A2 are present in a molar ratio of at least 4:1.

In this context, the molar ratio is again to be understood as the ratio of the amounts of the units in mol % based on the complete polyester chain. With regard to the above example of units derived from the group of monomers A being present e.g. in an amount of 100 mol % based on the complete unsaturated polyester chain represented by 200 mol %, a molar ratio of monomers A1 to A2 of 4:1 e.g. means 80 mol % of monomers A1 and 20 mol % of monomers A2 based on the complete polyester chain represented by 200 mol %, provided that no other units are present in the polyester chain.

According to the present invention, the monomers A1 are selected from the group consisting of unsaturated dicarboxylic acid based monomers of the following general formula (I)

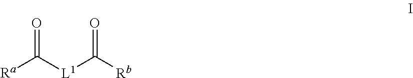

wherein
L¹ represents a linear or branched C₂-C₈-alkylene chain, and
   (i) R^{a} and R^{b} are independently selected from -halo, —OH, —OR¹, —NH₂ and —N(R¹)₂ with R¹ being —(C₁-C₆)alkyl or —C(═O)(C₁-C₄)alkyl, or
   (ii) R^{a}-R^{b} together represent an oxygen bridge —O—,
      and mixtures thereof.

In this context, a linear or branched C₂-C₈-alkylene chain has to be understood as a linear or branched alkylene chain comprising from 2 to 8 carbon atoms, wherein at least two of these carbon atoms are connected to each other via a double bond. Preferably, the C₂-C₈-alkylene chain comprises only one double bond, wherein said double bond may be present in (E)- or (Z)-configuration. The presence of a double bond may also be indicated by the term “unsaturation”, e.g. in the context of “unsaturated dicarboxylic acid based monomers”, which comprise L¹, i.e. a linear or branched C₂-C₈-alkylene chain.

Preferably, the monomers A1 are selected from the group consisting of unsaturated dicarboxylic acid based monomers of the following general formula (I)

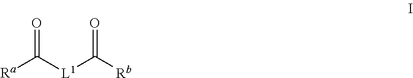

wherein
L¹ represents a linear C₂- or C₃-alkylene chain, and
   (i) R^{a} and R^{b} are independently selected from -halo, —OH, —OR¹, —NH₂ and —N(R¹)₂ with R¹ being —(C₁-C₆)alkyl or —C(═O)(C₁-C₄)alkyl, or
   (ii) R^{a}-R^{b} together represent an oxygen bridge —O—,
      and mixtures thereof.

In this context, a linear C₂- or C₃-alkylene chain has to be understood as a linear alkylene chain comprising from 2 to 3 carbon atoms, wherein two of these carbon atoms are connected to each other via a double bond. Said double bond may be present in (E)- or (Z)-configuration.

More preferably, the monomers A1 are selected from the group consisting of unsaturated dicarboxylic acid based monomers of the following general formula (I)

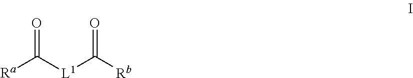

wherein
L¹ represents a C₂-alkylene chain, preferably a (Z)-configurated C₂-alkylene chain, and
   (i) R^{a} and R^{b} are independently selected from —OH, —OR¹ with R¹ being —(C₁-C₆)alkyl or —C(═O)(C₁-C₄)alkyl, or
   (ii) R^{a}-R^{b} together represent an oxygen bridge —O—,
      and mixtures thereof.

In this context, a C₂-alkylene chain has to be understood as an alkylene group comprising 2 carbon atoms, which are connected to each other via a double bond. Said double bond may be present in (E)- or (Z)-configuration, preferably in (Z)-configuration.

Most preferably, the monomers A1 represent an unsaturated dicarboxylic acid based monomer of the following general formula (I)

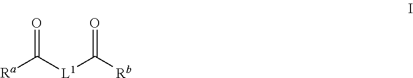

wherein
L¹ represents a (Z)-configurated C₂-alkylene chain, and
R^{a}-R^{b} together represent an oxygen bridge —O—.

Thus, the monomers A1 are preferably maleic anhydride of the following general formula (I′)

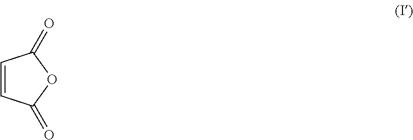

According to the present invention, the monomers A2 are selected from the group consisting of dicarboxylic acid based monomers of the following general formula (II)

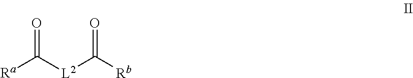

wherein
L² represents a linear or branched C₁-C₁₈-alkyl chain or a benzene ring, and
   (i) R^{a} and R^{b} are independently selected from -halo, —OH, —OR¹, —NH₂ and —N(R¹)₂ with R¹ being —(C₁-C₆)alkyl or —C(═O)(C₁-C₄)alkyl, or
   (ii) R^{a}-R^{b} together represent an oxygen bridge —O—,
and mixtures thereof.

In this context, a linear or branched C₁-C₁₈-alkyl chain has to be understood as a linear or branched alkyl chain comprising from 1 to 18 carbon atoms, which are connected to each other via single bonds. A benzene ring has to be understood as a C₆-aromatic ring, which is preferably unsubstituted.

Preferably, the monomers A2 are selected from the group consisting of dicarboxylic acid based monomers of the following general formula (II)

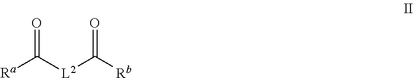

wherein
L² represents a linear or branched C₁-C₁₀-alkyl chain or a benzene ring, and
   (i) R^{a} and R^{b} are independently selected from -halo, —OH, —OR¹, —NH₂ and —N(R¹)₂ with R¹ being —(C₁-C₆)alkyl or —C(═O)(C₁-C₄)alkyl, or
   (ii) R^{a}-R^{b} together represent an oxygen bridge —O—,
and mixtures thereof.

In this context, a linear or branched C₁-C₁₀-alkyl chain has to be understood as a linear or branched alkyl chain comprising from 1 to 10 carbon atoms, which are connected to each other via single bonds. A benzene ring has to be understood as a C₆-aromatic ring, which is preferably unsubstituted.

More preferably, the monomers A2 are selected from the group consisting of dicarboxylic acid based monomers of the following general formula (II)

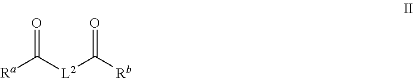

wherein
L² represents a linear or branched C₁-C₆-alkyl chain or a benzene ring, and
   (i) R^{a} and R^{b} are independently selected from —OH, —OR¹ with R¹ being —(C₁-C₆)alkyl or —C(═O)(C₁-C₄)alkyl, or
   (ii) R^{a}-R^{b} together represent an oxygen bridge —O—,
and mixtures thereof.

In this context, a linear or branched C₁-C₆-alkyl chain has to be understood as a linear or branched alkyl chain comprising from 1 to 6 carbon atoms, which are connected to each other via single bonds. A benzene ring has to be understood as a C₆-aromatic ring, which is preferably unsubstituted.

Most preferably, the monomers A2 are selected from the group consisting of dicarboxylic acid based monomers of the following general formula (II)

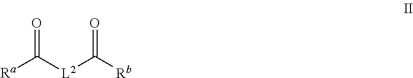

wherein
L² represents a linear C₁-C₄-alkyl chain or a benzene ring, and
   (i) R^{a} and R^{b} are independently selected from -halo, —OH, —OR¹ with R¹ being —(C₁-C₆)alkyl or —C(═O)(C₁-C₄)alkyl, or
   (ii) R^{a}-R^{b} together represent an oxygen bridge —O—,
and mixtures thereof.

In this context, a linear or branched C₁-C₄-alkyl chain has to be understood as a linear or branched alkyl chain comprising from 1 to 4 carbon atoms, which are connected to each other via single bonds. A benzene ring has to be understood as a C₆-aromatic ring, which is preferably unsubstituted.

According to the present invention, the group of monomers B consists of

(b1) monomers B1,
(b2) monomers B2, or
(b3) monomers B1 and B2.

Thus, the group of monomers B may either exclusively comprise the monomers B1 or exclusively comprise the monomers B2, or the group of monomers B may comprise the monomers B1 in combination with monomers B2, wherein the monomers B1 and B2 may be present in any molar ratio.

According to the present invention, the monomers B1 are selected from the group consisting of ethylene glycol based monomers of the following general formula (III)

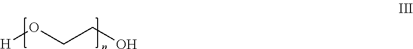

wherein n is an integer of from 1 to 300,
and mixtures thereof.

In a preferred embodiment, the monomers B1 are selected from high molecular weight ethylene glycol based monomers, wherein n in formula (III) is an integer of from 7 to 300, preferably from 20 to 300.

In another preferred embodiment, the monomers B1 are selected from mixtures of high molecular weight ethylene glycol based monomers, wherein n in formula (III) is an integer of from 7 to 300, preferably from 20 to 300, with low molecular weight ethylene glycol based monomers, wherein n in formula (III) is 1, 2, 3, 4, 5 or 6, preferably 1 or 2. Preferably, high molecular weight ethylene glycol based monomers and low molecular weight glycol monomers are used in a weight ratio of from 1:1 to 20:1, preferably from 5:1 to 15:1, more preferably from 8:1 to 12:1.

It has been found that mixtures are particularly suitable, if high molecular weight ethylene glycol based monomers are used in combination with low molecular weight ethylene glycol based monomers as monomers B1. In particular, it seems that the low molecular weight ethylene glycol based monomers, i.e. ethylene glycol based monomers wherein n is 1, 2, 3, 4, 5 or 6, preferably 1 or 2, are advantageous for cross-linking the polyester. Thus, it is preferred that ethylene glycol based monomers, wherein n is an integer of from 7 to 300, preferably 20 to 300, are used in a mixture with ethylene glycol based monomers, wherein n is 1, 2, 3, 4, 5 or 6, preferably 1 or 2.

In another preferred embodiment, the monomers B1 are selected from the group consisting of ethylene glycol based monomers of the following general formula (III)

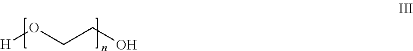

wherein n is 1, 2, 3, 4, 5 or 6, preferably 1, 2, 3 or 4, more preferably 1 or 2,
and mixtures thereof.

More preferably, the monomers B1 are ethylene glycol based monomers of the following general formula (III)

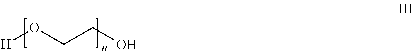

wherein n is 2.

It has been found that, if e.g. diethylene glycol is used as monomer B1, the water absorption capacity of the cross-linked polyesters can be significantly improved. Alternatively, high molecular weight polyethylene glycols, wherein n in formula (III) is an integer of from 7 to 300, preferably from 20 to 300, may be used either alone or in combination with a low molecular weight polyethylene glycol such as diethylene glycol.

According to the present invention, the monomers B2 are selected from the group consisting of propylene glycol based monomers of the following general formula (IV)

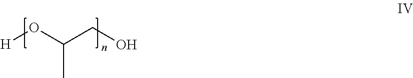

wherein n is 1, 2, 3, 4, 5 or 6,
and mixtures thereof.

Preferably, the monomers B2 are selected from the group consisting of propylene glycol based monomers of the following general formula (IV)

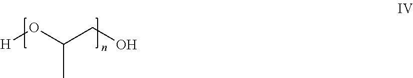

wherein n is 1, 2, 3, or 4,
and mixtures thereof.

More preferably, the monomers B2 are propylene glycol based monomers of the following general formula (IV)

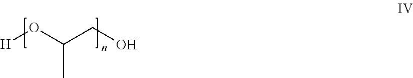

wherein n is 2.

The cross-linked polyester according to the present invention may also be defined by the structures of the units derived from the groups of monomers A and B as defined above. The positions, where each unit is connected to a further unit will be represented by a wavy line in the following.

According to the present invention, the cross-linked polyester comprises units derived from monomers A1 or units derived from monomers A1 and A2, with units derived from monomers A1 and units derived from monomers A2 being present in a molar ratio of at least 4:1.

According to the present invention, the units derived from monomers A1 are selected from the group consisting of units having the following structure (I*):

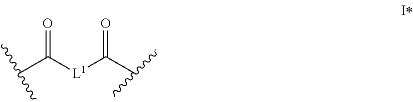

wherein L¹ represents a linear or branched C₂-C₈-alkylene chain, and mixtures thereof.

Preferably, the units derived from monomers A1 are represented by the structure (I*), wherein L¹ represents a linear or branched C₂-C₄-alkylene chain, more preferably a C₂-alkylene group.

According to the present invention, the units derived from monomers A2 are selected from the group consisting of units having the following structure (II*):

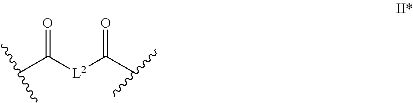

wherein L² represents a linear or branched C₁-C₁₈-alkyl chain or a benzene ring, and mixtures thereof.

Preferably, the units derived from monomers A2 are represented by the structure (II*), wherein L² represents a linear or branched C₁-C₄-alkyl chain or a benzene ring.

According to the present invention, the cross-linked polyester comprises units derived from monomers B1 or units derived from monomers B2, or units derived from monomers B1 and monomers B2.

According to the present invention, the units derived from monomers B1 are selected from the group consisting of units having the following structure (III*):

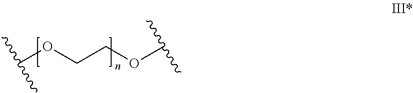

wherein n is an integer of from 1 to 300 and mixtures thereof.

Preferably, the units derived from monomers B1 are represented by the structure (III*), wherein n is 1, 2, 3, 4, 5 or 6, preferably 1, 2, 3 or 4, and mixtures thereof. Alternatively, the units derived from monomers B1 are represented by the structure (III*), wherein n is an integer of from 7 to 300, preferably 20 to 300. Furthermore, mixtures of the units may be present.

According to the present invention, the units derived from monomers B2 are selected from the group consisting of units having the following structure (IV*):

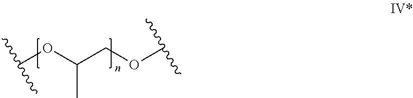

wherein n is 1, 2, 3, 4, 5 or 6, and mixtures thereof.

Preferably, the units derived from monomers B2 are represented by the structure (IV*), wherein n is 1, 2, 3 or 4 and mixtures thereof.

The unsaturated polyester chains comprising units as indicated above, i.e. units derived from groups of monomers A and B, can be prepared by a heat-activated condensation reaction. Preferably, the group of monomers A is reacted with an approximately equimolar amount of the group of monomers B at a temperature of from 150° C. to 250° C. for a time period of from 1 h to 3 h, and then vacuum is applied to the reaction mixture, in order to remove any residual water.

For the water absorption capacity, it is essential that the unsaturated polyester chains comprising units as indicated above, i.e. units derived from groups of monomers A and B, are inter-molecularly cross-linked to obtain a cross-linked polyester.

In a preferred embodiment, the unsaturated polyester chains are inter-molecularly cross-linked via the double bonds contained therein, preferably in the absence of an unsaturated cross-linking agent.

As used herein, the term “cross-linking agent” is to be understood as an agent, which is suitable for forming a bridge between two polyester chains, so that a three dimensional network is established. Such a cross-linking agent may e.g. be an unsaturated monomer such as styrene, which reacts with the double bonds contained in the unsaturated polyester chains, so that the polyester chains are cross-linked by styrene based bridges.

Cross-linking in the absence of a cross-linking agent therefore has to be understood as such that cross-linking is achieved in that the unsaturated polyester chains are directly cross-linked with each other by reacting the double bonds contained therein with each other, i.e. no bridge is formed between the polyester chains, which would be based on a cross-linking agent. Accordingly, it is not necessary for cross-linking to add an unsaturated monomer such as styrene.

In a preferred embodiment, such a cross-linked polyester is obtainable by thermal cross-linking at a temperature of from 150° C. to 250° C. for at least 20 h, optionally in the presence of a peroxide. If cross-linking is performed in the absence of a peroxide, vacuum is preferably applied during heat treatment. If a peroxide is used, said peroxide is preferably hydrogen peroxide or sodium persulfate. Alternatively, the peroxide may be an organic peroxide such as tert-butylperbenzoate, 1,1-di-(tert.-butylperoxy-)3,3,5-trimethylcyclohexane, dicumylperoxide, 1,1-di-(t-amylperoxy) cyclohexane, 1,1-di-(t-butylperoxy) 3,3,5-trimethyl cyclohexane, 1,1-di-(t-butylperoxy) cyclohexane, t-amyl peroxybenzoate, t-butyl peroxyacetate, t-butyl peroxybenzoate, ethyl 3,3-di-(t-amylperoxy) butyrate, ethyl 3,3-di-(t-butylperoxy) butyrate, cumyl peroxyneodecanoate, cumyl peroxyneopheptanoate, t-amyl peroxyneodecanoate, t-butyl peroxyneodecanoate, di-(2-ethylhexyl) peroxy-dicarbonate, t-amyl peroxypivalate, t-butyl peroxypivalate, 2,5-dimethyl-2,5 bis(2-ethyl-hexanoylperoxy)hexane, dibenzoyl peroxide, t-amyl peroxy-2-ethylhexanoate, and t-butyl peroxy-2-ethylhexanoate,

When defining the cross-linked polyester of the invention comprising the units derived from the groups of monomers A and B by specifying the groups of monomers A and B as indicated above, the cross-linked polyester is defined by specifying the precursors, from which the cross-linked polyester is obtainable. It is of course particularly advantageous to use structurally simple and preferably commercially available precursors. Accordingly, the following monomers may be considered as particularly preferred.

In a preferred embodiment of the present invention, the monomers A1 are selected from the group consisting of maleic acid based monomers, fumaric acid based monomers, glutaconic acid based monomers, itaconic acid based monomers and mixtures thereof, and are preferably selected from the group consisting of maleic acid based monomers, and are particularly preferably maleic anhydride monomers.

In another preferred embodiment of the present invention, the monomers A2 are selected from the group consisting of terephthalic acid based monomers, isophthalic acid based monomers, phthalic acid based monomers, malonic acid based monomers, succinic acid based monomers, glutaric acid based monomers, adipic acid based monomers, pimelic acid based monomers, suberic acid based monomers, azelaic acid based monomers, sebacic acid based monomers and mixtures thereof, and are preferably selected from the group consisting of therephthalic acid based monomers, succinic acid based monomers, adipic acid based monomers, sebacic acid based monomers and mixtures thereof, and are more preferably selected from the group consisting of succinic acid based monomers and adipic acid based monomers, and are particularly preferably adipic acid monomers.

In another preferred embodiment of the present invention, the monomers B1 are selected from the group consisting of ethyleneglycol monomers, diethyleneglycol monomers, triethyleneglycol monomers and mixtures thereof, and are preferably diethyleneglycol monomers.

In another preferred embodiment of the present invention, the monomers B2 are selected from the group consisting of propyleneglycol monomers, dipropyleneglycol monomers and mixtures thereof, and are preferably dipropyleneglycol monomers.

In one embodiment of the present invention, the cross-linked polyester comprises units derived from groups of monomers A and B,

(a) wherein the group of monomers A consists of maleic anhydride monomers A1; and
(b) wherein the group of monomers B consists of diethyleneglycol monomers B1.

Preferably, the molar ratio of the units derived from the group of monomers A to the units derived from the group of monomers B is from 1.1:1 to 1:1.1 in the unsaturated polyester chains, from which the cross-linked polyester is derived.

Thus, the cross-linked polyester preferably comprises the following units derived from the group of monomers A:

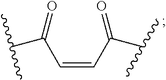 [SMILES: *C(=O)/C=C\C(*)=O]

and the following units derived from the group of monomers B

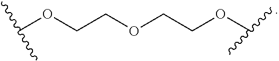 [SMILES: *OCCOCCO*]

Preferably, the molar ratio of the above units derived from the groups of monomers A to the above units derived from the group of monomers B is from 1.1:1 to 1:1.1.

In another embodiment of the present invention, the cross-linked polyester has a melting temperature Tₘ of from 40° C. to 80° C., preferably from 50° C. to 70° C. As a consequence, the cross-linked polyester has a low stickiness and a high flowability, if provided e.g. in granular or particulate form.

The cross-linked polyester of the invention exhibits a particularly high water absorption capacity.

In a preferred embodiment of the invention, the cross-linked polyester is capable of absorbing water or an aqueous solution in an amount of at least 30 g, preferably in an amount of at least 40 g, more preferably in an amount of at least 50 g, per gram of the cross-linked polyester, at a temperature of from 20° C. to 30° C. for an absorption time of 1 day.

In another preferred embodiment of the invention, the cross-linked polyester is capable of absorbing water or an aqueous solution in an amount of at least 30 g, preferably in an amount of from 30 g to 200 g, more preferably in an amount of from 40 g to 150 g, most preferably from 50 g to 140 g, per gram of the cross-linked polyester, at a temperature of from 20° C. to 30° C. for an absorption time of 1 day.

Furthermore, the cross-linked polyester is advantageous in terms of its biodegradability.

In a preferred embodiment of the present invention, the cross-linked polyester is biodegradable in soil by at least 20%, preferably at least 30%, more preferably at least 45%, most preferably at least 50% at a temperature of from 20° C. to 30° C. after 140 days, wherein the percentage value is calculated from the CO₂ formation compared to the carbon content of the tested amount of the cross-linked polyester. In particular, the percentage value defines the amount of carbon in mg, which has been converted the carbon dioxide, compared to the amount of carbon in mg in the tested sample of the cross-linked polyester, which may be determined by elemental analysis.

The present invention is also directed to a composition comprising as compounds the cross-linked polyester according to the invention, and saw dust. Preferably, the two compounds are together present in an amount of at least 90 wt.-%, more preferably in an amount of at least 99 wt.-%. Also said composition of the invention is advantageous in terms of its water absorption capacity and its biodegradability.

Furthermore, the present invention is directed to an absorbent material comprising the cross-linked polyester according to the invention or the composition according to the invention. Preferably, the cross-linked polyester or the composition is present in an amount of at least 50%, more preferably at least 75%, most preferably at least 90% based on the total weight of the absorbent material.

Moreover, the present invention is directed to a soil treatment product comprising as compounds the cross-linked polyester according to the invention or the composition according to the invention, and at least one additional compound selected from the group consisting of organic and/or inorganic fillers, nutrients, fertilizers, pesticides, fungicides, herbicides and combinations thereof. Preferably, the compounds are together present in an amount of at least 50%, preferably at least 75%, more preferably at least 90% based on the total weight of the soil treatment product. More preferably, the cross-linked polyester according to the invention or the composition according to the invention and the additional compound are present in a weight ratio of from 80:20 to 20:80.

The soil treatment product according to the present invention is suitable for agricultural applications. For this purpose, the soil treatment product is preferably present in dry granular form, wherein the granulates exhibit good flow properties.

The present invention is also directed to the use of the cross-linked polyester according to the invention or the composition according to the invention for agricultural applications.

In a preferred embodiment, the cross-linked polyester according to the invention or the composition according to the invention can be used for improving the physiological properties of soils. This may e.g. be achieved by increasing their capacity to hold water, reducing erosion and runoff, reducing the frequency of irrigation, increasing the efficiency of the water being used, increasing soil permeability and infiltration, reducing the tendency of the soil to get compacted, and helping plant performance. In particular, the cross-linked polyester according to the invention or the composition according to the invention may be used for improving the physiological properties of plant soil, garden soil, meadow soil, lawn soil, forest soil, field soil, for preparing soils for cultivating plants, and for recultivating of fields, which have become deserted.

In another preferred embodiment, the cross-linked polyester according to the invention or the composition according to the invention is used for absorbing and storing humidity in soils, e.g. in areas under cultivation of plants. Alternatively or additionally, it is preferred that the cross-linked polyester according to the invention or the composition according to the invention is used for improving the soil structure by loosening the soil. Furthermore, the soil treatment product may also be used for uniformly distributing nutrients, minerals and fertilizers, wherein the nutrients, minerals and fertilizers are preferably released in a controlled manner over a time period of at least one month.

For the uses indicated above, the composition or the soil treatment product of the invention will preferably be added to the soil in an amount of 1 to 1000 kg/ha, preferably in an amount of 1 to 25 kg/ha field, or in an amount of from 0.1 to 100 kg/T soil.

As an effect, plant growth can significantly be accelerated.

In a preferred embodiment, plant growth is accelerated by using the cross-linked polyester or the composition of the invention in that the weight of a plant in treated soil is increased by at least 20%, preferably by at least 30%, most preferably by at least 40% compared to the weight of a plant in untreated soil, wherein the percentage value corresponds to the weight increase of the dry weight of the plant in treated soil after 3 weeks cultivation at a temperature of from 20° C. to 30° C. compared to the plant in untreated soil.

In a preferred embodiment, the yield of a plant is increased by using the cross-linked polyester or the composition of the invention in that the yield of a plant grown in treat soil is increased by at least 4%, preferably at least 7%, more preferably at least 10%, most preferably at least 14%, particularly preferably at least 19%, particularly at least 24%, for example at least 29% compared to the yield of a plant in untreated soil. The plant for which the yield is increased is preferably a field crop, such as potatoes, sugar beets, tobacco, wheat, rye, barley, oats, rice, corn, cotton, soybeans, rape, legumes, sunflowers, coffee or sugar cane; fruits; vines; ornamentals; or vegetables, such as cucumbers, tomatoes, beans or squashes. More preferably, the plant for which the yield is increased is a vegetable selected from cucumbers, tomatoes, beans or squashes, and is most preferably tomato.

The invention is further illustrated by the examples, which are not to be understood as limiting the invention, however.

### EXAMPLES

### A. Determination Methods

The following definitions of terms and determination methods apply for the above general description of the invention including the claims as well as to the below examples unless otherwise defined.

### a) Determining the Water Absorption Capacity (Tea Bag Analysis)

The water absorption capacity can be determined by the “tea bag analysis” using deionized water.

The polyester is grinded and sieved, and the sieve fraction of 150-800 μm is used for testing. The polyester is dried and the residual moisture content is determined. 100 mg of the dry polyester is placed in a first teabag 1, and the teabag 1 is then sealed with a film sealer. Another 100 mg of the dry polyester is placed in a second teabag 2, and the teabag 2 is then sealed with a film sealer. Both teabags 1 and 2 are placed in 700 ml deionized water and stored at ambient temperature. Three further teabags 3, 4 and 5 without polyester are also placed in 700 ml deionized water and stored at ambient temperature.

After 24 hours, the teabags 1 and 2 are taken out of the water and hanged out inclined for 10 minutes to let the water drain off. Then the weight of teabags 1 and 2 is determined. Similarly, teabags 3, 4 and 5 are taken out of the water and hanged out inclined for 10 minutes to let the water drain off. Then the weight of teabags 3, 4 and 5 is determined and the average weight W₀ is determined. After that, teabags 1 and 2 are again placed in 700 ml deionized water and stored at ambient temperature.

After 48 hours, the teabags 1 and 2 are taken out of the water and hanged out inclined for 10 minutes to let the water drain off. Then the weight of teabags 1 and 2 is determined. After that, teabags 1 and 2 are again placed in 700 ml deionized water and stored at ambient temperature.

After 168 hours, the teabags 1 and 2 are taken out of the water and hanged out inclined for 10 minutes to let the water drain off. Then the weight of teabags 1 and 2 is determined.

The weight of the absorbed water is determined for the absorption times of 24 hours, 48 hours and 168 hours as follows:

Weight of absorbed water=Weight of teabag 1−Weight of dry polymer−W₀

Weight of absorbed water=Weight of teabag 2−Weight of dry polymer−W₀

Then, the weight of absorbed water is normalized to 1 g of dry polyester.

The results are provided as the weight of absorbed water in gram per weight of the dry polyester in gram [g (water)/g (polyester] after 24, 48 and 168 hours, respectively.

### b) Determining the Biological Degradability (Biodegradability)

The mineralization of the polyester is measured using the method and the manometric measurement system described by Robertz, M. et al. (“Cost-effective method of determining soil respiration in contaminated and uncontaminated soils for scientific and routine analysis” published in: Wise, D. L., et al. (eds.) Remediation Engineering of Contaminated Soil, 573-582, Marcel Dekker Inc., New York, Basel, 2000). The carbon mineralization is expressed as the difference in the accumulated soil respiration (CO₂ formation) with the polyester added minus without the polyester added. Per measuring unit, 50 g of dry soil is used to which water is added up to 50% of its maximum water holding capacity. The amount of the polyester added is equivalent to 50 mg C determined by elementary analysis. The soil used is a light textured soil from Limburgerhof, Germany, with pH 6.8. The results are the average of 4 replicates.

### c) Determining the Acceleration of Plant Growth (Cylinder Test)

With the aid of the test described hereinafter, the effects of the inventive polyesters on the shoot and root growth of corn plants (plant growth) can be measured. The polyester to be studied (0.01-10 g/kg) is added to a water-moistened plant substrate and mixed in until homogeneously distributed. To determine the blank value, correspondingly moistened quartz sand is used. Then five precultivated corn seedlings were planted into each pretreated substrate and cultivated at ambient temperature for about 3 weeks, in the course of which the plants are watered with a compound fertilizer solution once per week. The plants are removed from the pots along with the roots, the roots are cleaned by washing and the plants are assessed for appearance and size. Then the shoot and root are separated from each other in each case and both parts are weighed to determine their fresh weight. The shoots and roots are subsequently dried to constant weight and their dry weights are determined. The final weights for the shoots and roots of 5 identically treated plants in each case are used to calculate the mean values for fresh and dry weights.

### d) Determining the Stickiness and Flowability

The stickiness and flowability properties of the polyester are tested visually.

### B. Examples

### Example 1

### a) Preparation of Unsaturated Polyesters

88.3 g Maleic anhydride, 918 g Pluriol E6000 (polyethylenglycole with Mn of 6000), 79.3 g diethylenglycole and 0.75 g tetrabutylorthotitanate are reacted at a temperature of 180° C. for about 2 h, whereby water is distilled off. Then, the temperature is raised to 200° C. and vacuum is applied. The obtained polyester has a hydroxyl value of 31 mgKOH/g and an acid value of 25 mgKOH/g.

### b) Preparation of Cross-Linked Polyesters

The unsaturated polyester according to 1a) is heat treated at a temperature of 200° C. under vacuum to obtain a cross-linked polyester. The cross-linked polyester is then stored in a drying oven for 24 h.

### Example 2

### a) Preparation of Unsaturated Polyesters

11.8 g Maleic anhydride, 120 g Pluriol E4000 (polyethylenglycole with Mn of 4000), 10.82 g diethylenglycole and 0.1 g tetrabutylorthotitanate are reacted at a temperature of 180° C. for about 2 h, whereby water is distilled off. Then, the temperature is raised to 200° C. and vacuum is applied. The obtained polyester has a hydroxyl value of 28 mgKOH/g and an acid value of 18 mgKOH/g.

### b) Preparation of Cross-Linked Polyesters

The unsaturated polyester according to 2a) is heat treated at a temperature of 200° C. under vacuum to obtain a cross-linked polyester. The cross-linked polyester is then stored in a drying oven for 24 h.

### Example 3

### a) Preparation of Unsaturated Polyesters

11.8 g Maleic anhydride, 126 g Pluriol E1000 (polyethylenglycole with Mn of 1000), and 0.1 g tetrabutylorthotitanate are reacted at a temperature of 180° C. for about 2 h, whereby water is distilled off. Then, the temperature is raised to 200° C. and vacuum is applied. The obtained polyester has a hydroxyl value of 27 mgKOH/g and an acid value of 19 mgKOH/g.

### b) Preparation of Cross-Linked Polyesters

The unsaturated polyester according to 3a) is heat treated at a temperature of 200° C. under vacuum to obtain a cross-linked polyester. The cross-linked polyester is then stored in a drying oven for 24 h.

### Example 4

### a) Preparation of Unsaturated Polyesters

19.6 g Maleic anhydride, 126 g Pluriol E600 (polyethylenglycole with Mn of 600), and 0.1 g tetrabutylorthotitanate are reacted at a temperature of 180° C. for about 2 h, whereby water is distilled off. Then, the temperature is raised to 200° C. and vacuum is applied. The obtained polyester has a hydroxyl value of 31 mgKOH/g and an acid value of 21 mgKOH/g.

### b) Preparation of Cross-Linked Polyesters

The unsaturated polyester according to 4a) is heat treated at a temperature of 200° C. under vacuum to obtain a cross-linked polyester. The cross-linked polyester is then stored in a drying oven for 24 h.

### Example 5

### a) Preparation of Unsaturated Polyesters

19.6 g Maleic anhydride, 80.3 g Pluriol E400 (polyethylenglycole with Mn of 400), and 0.07 g tetrabutylorthotitanate are reacted at a temperature of 180° C. for about 2 h, whereby water is distilled off. Then, the temperature is raised to 200° C. and vacuum is applied. The obtained polyester has a hydroxyl value of 21 mgKOH/g and an acid value of 15 mgKOH/g.

### b) Preparation of Cross-Linked Polyesters

The unsaturated polyester according to 5a) is heat treated at a temperature of 200° C. under vacuum to obtain a cross-linked polyester. The cross-linked polyester is then stored in a drying oven for 24 h.

### Example 6

### Determination of the Water Absorption Capacities of the Cross-Linked Polyester Compared to the Unsaturated Polyester

The cross-linked polyesters are tested in terms of the water absorption capacity, the biodegradability, the plant growth, the stickiness and flowability properties, in order to determine the influence of the molar ratio of the units derived from the groups of monomers A and B on the properties of the polyester.

The results are provided in the following table 1:

| | | Water ab- | | | |
|---|---|---|---|---|---|
| Exam- | | sorption | Biodegrad- | Plant | Stickiness/ |
| ple | PEG | capacity* | ability** | growth*** | Flowability**** |
| 1 | 6000 | High | High | High | Good |
| 2 | 4000 | High | High | High | Good |
| 3 | 1000 | High | High | High | Good |
| 4 | 600 | High | High | High | Good |
| 5 | 400 | Medium | High | High | Good |

*High water absorption capacity means at least 40 g/g, medium water absorption capacity means at least 30 g/g, and low water absorption capacity means below 30 g/g at a temperature of from 20° C. to 30° C. for an absorption time of 1 day.
**High biodegradability means at least 45%, preferably at least 50% at a temperature of from 20° C. to 30° C. after 140 days.
***High plant growth means at least 35% yield, preferably at least 40% yield in the cylinder test, medium plant growth means at least 30% yield in the cylinder test after 3 weeks at a temperature of from 20° C. to 30° C.
****Stickiness/flowabilty properties were visually determined.

### Field Test First Year (2013)

Cross linked hydrogel of Example 1 was also used for field test with tomatoes. The hydrogel was used with the average amount of 20 kg/ha. The yield/harvest of tomato fruits with and without hydrogel were compared.

Without Hydrogel: 100%

With Hydrogel: 114%

Thus positive effect of the hydrogel for the yield of tomato was confirmed in the real field test.

### Field Test Second Year (2014)

Cross linked hydrogel of Example 1 was also used for field test with tomatoes. The hydrogel was used with the average amount of 10 kg/ha. The yield/harvest of tomato fruits with and without hydrogel were compared.

Without Hydrogel: 100%

With Hydrogel: ripe tomato: 102%, unripe tomato: 131%

Thus positive effect of the hydrogel for the yield of tomato was confirmed in the real field test.

1-16. (canceled)

17. Cross-linked polyester derived from unsaturated polyester chains, which are inter-molecularly cross-linked and comprise units derived from groups of monomers A and B,
wherein
(a) the group of monomers A consists of
(a1) monomers A1, or
(a2) monomers A1 and monomers A2, with monomers A1 and monomers A2 being present in a molar ratio of at least 4:1,
wherein the monomers A1 are selected from the group consisting of unsaturated dicarboxylic acid based monomers of the following general formula (I) 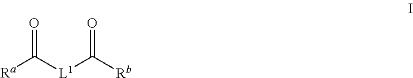
wherein
L¹ represents a linear or branched C₂-C₈-alkylene chain, and
(i) R^{a} and R^{b} are independently selected from -halo, —OH, —OR¹, —NH₂ and —N(R¹)₂ with R¹ being —(C₁-C₆)alkyl or —C(═O)(C₁-C₄)alkyl, or
(ii) R^{a}-R^{b} together represent an oxygen bridge —O—,
and mixtures thereof, and
wherein the monomers A2 are selected from the group consisting of dicarboxylic acid based monomers of the following general formula (II) 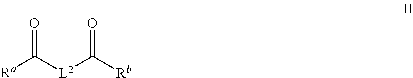
wherein
L² represents a linear or branched C₁-C₁₈-alkyl chain or a benzene ring, and
(i) R^{a} and R^{b} are independently selected from -halo, —OH, —OR¹, —NH₂ and —N(R¹)₂ with R¹ being —(C₁-C₆)alkyl or —C(═O)(C₁-C₄)alkyl, or
(ii) R^{a}-R^{b} together represent an oxygen bridge —O—,
and mixtures thereof,
(b) the group of monomers B consists of
(b1) monomers B1,
wherein the monomers B1 are selected from the group consisting of ethylene glycol based monomers of the following general formula (III) 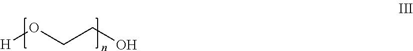
wherein n is an integer of from 1 to 300,
and mixtures thereof,
wherein the molar ratio of the units derived from the group of monomers A to the units derived from the group of monomers B is from 1.3:1 to 1:1.3 in the unsaturated polyester chains, and wherein the units derived from the groups of monomers A and B are together present in an amount of at least 90 wt.-% based on the total weight of the cross-linked polyester.

18. The cross-linked polyester according to claim 17, wherein the units derived from the groups of monomers A and B are together present in an amount of at least 95 wt.-% based on the total weight of the cross-linked polyester.

19. The cross-linked polyester according to claim 17, wherein the units derived from the groups of monomers A and B are together present in an amount of at least 99 wt.-% based on the total weight of the cross-linked polyester.

20. The cross-linked polyester according to claim 17, wherein the unsaturated polyester chains are inter-molecularly cross-linked via the double bonds contained therein.

21. The cross-linked polyester according to claim 17, wherein cross-linking is achieved by inter-molecularly reacting the unsaturated polyester chains at a temperature from 150° C. to 250° C. for at least 20 h, optionally in the presence of a peroxide.

22. The cross-linked polyester according to claim 17,
(a1) wherein the monomers A1 are selected from the group consisting of maleic acid based monomers, fumaric acid based monomers, glutaconic acid based monomers, itaconic acid based monomers and mixtures thereof, and are preferably selected from the group consisting of maleic acid based monomers, and are particularly preferably maleic anhydride monomers; and/or
(a2) wherein the monomers A2 are selected from the group consisting of terephthalic acid based monomers, isophthalic acid based monomers, phthalic acid based monomers, malonic acid based monomers, succinic acid based monomers, glutaric acid based monomers, adipic acid based monomers, pimelic acid based monomers, suberic acid based monomers, azelaic acid based monomers, sebacic acid based monomers and mixtures thereof, and are preferably selected from the group consisting of therephthalic acid based monomers, succinic acid based monomers, adipic acid based monomers, sebacic acid based monomers and mixtures thereof, and are more preferably selected from the group consisting of succinic acid based monomers and adipic acid based monomers, and are particularly preferably adipic acid monomers and/or;
(b1) wherein the monomers B1 are selected from the group consisting of ethyleneglycol monomers, diethyleneglycol monomers, triethyleneglycol monomers and mixtures thereof, and are preferably diethyleneglycol monomers.

23. The cross-linked polyester according to claim 17,
(a1) wherein the monomers A1 are selected from the group consisting of maleic acid based monomers, fumaric acid based monomers, glutaconic acid based monomers, itaconic acid based monomers and mixtures thereof, and are preferably selected from the group consisting of maleic acid based monomers, and are particularly preferably maleic anhydride monomers; and/or
(a2) wherein the monomers A2 are selected from the group consisting of terephthalic acid based monomers, isophthalic acid based monomers, phthalic acid based monomers, malonic acid based monomers, succinic acid based monomers, glutaric acid based monomers, adipic acid based monomers, pimelic acid based monomers, suberic acid based monomers, azelaic acid based monomers, sebacic acid based monomers and mixtures thereof, and are preferably selected from the group consisting of therephthalic acid based monomers, succinic acid based monomers, adipic acid based monomers, sebacic acid based monomers and mixtures thereof, and are more preferably selected from the group consisting of succinic acid based monomers and adipic acid based monomers, and are particularly preferably adipic acid monomers and/or;
(b1) wherein the monomers B1 are selected from high molecular weight ethylene glycol based monomers, wherein n in formula (III) is an integer of from 7 to 300, preferably from 20 to 300; or
wherein the monomers B1 are mixtures of high molecular weight ethylene glycol based monomers, wherein n in formula (III) is an integer of from 7 to 300, preferably from 20 to 300, with low molecular weight ethylene glycol based monomers, wherein n in formula (III) is 1, 2, 3, 4, 5 or 6, preferably 1 or 2.

24. The cross-linked polyester according to claim 23,
wherein the monomers B1 are mixtures of high molecular weight ethylene glycol based monomers, wherein n in formula (III) is an integer of from 7 to 300, preferably from 20 to 300, with low molecular weight ethylene glycol based monomers, wherein n in formula (III) is 1, 2, 3, 4, 5 or 6, preferably 1 or 2,
wherein the high molecular weight ethylene glycol based monomers and the low molecular weight glycol monomers are present in a weight ratio of from 1:1 to 20:1, preferably from 5:1 to 15:1, more preferably from 8:1 to 12:1.

25. The cross-linked polyester according to claim 17,
(a) wherein the group of monomers A consists of maleic anhydride monomers A1; and
(b) wherein the group of monomers B consists of diethyleneglycol monomers B1;
and
wherein the molar ratio of the units derived from the group of monomers A to the units derived from the group of monomers B is preferably from 1.1:1 to 1:1.1 in the unsaturated polyester chains, from which the cross-linked polyester is derived.

26. The cross-linked polyester according to claim 17, wherein the cross-linked polyester has a melting temperature Tₘ of from 40° C. to 80° C., preferably from 50° C. to 70° C.

27. The cross-linked polyester according to claim 17, wherein the cross-linked polyester is capable of absorbing water or an aqueous solution in an amount of at least 30 g, preferably in an amount of from 30 g to 200 g, more preferably in an amount of from 40 g to 150 g, most preferably from 50 g to 140 g, per gram of the cross-linked polyester, at a temperature of from 20° C. to 30° C. for an absorption time of 1 day.

28. The cross-linked polyester according to claim 17, wherein the cross-linked polyester is biodegradable in soil by at least 20%, preferably at least 30%, more preferably at least 45%, most preferably at least 50% at a temperature of from 20° C. to 30° C. after 140 days, wherein the percentage value defines the amount of carbon in mg, which has been converted the carbon dioxide, compared to the amount of carbon in mg in the tested sample of the cross-linked polyester.

29. A composition comprising as compounds
(a) the cross-linked polyester according to claim 17, and
(b) saw dust or flax dust or a combination thereof,
wherein the two compounds are preferably together present in an amount of at least 90 wt.-%.

30. An absorbent material comprising the cross-linked polyester according to claim 17 or the composition of claim 29,
wherein the cross-linked polyester or the composition is preferably present in an amount of at least 50%, more preferably at least 75%, most preferably at least 90% based on the total weight of the absorbent material.

31. A soil treatment product comprising as compounds
(a) the cross-linked polyester according to claim 17 or the composition of claim 29, and
(b) at least one additional compound selected from the group consisting of fillers, nutrients, fertilizers, pesticides and combinations thereof,
wherein the compounds are preferably together present in an amount of at least 50%, preferably at least 75%, more preferably at least 90% based on the total weight of the soil treatment product.

32. A method for improving the physiological properties of soils, comprising treating the soils with a composition comprising the cross-linked polyester according to claim 17 wherein plant growth is accelerated in that the weight of a plant in treated soil is increased by at least 20% and wherein the percentage value corresponds to the weight increase of the dry weight of the plant in treated soil after 3 weeks cultivation at a temperature of from 20° C. to 30° C. compared to the plant in untreated soil.

33. The method of claim 32, wherein the units in the crosslinked polyester derived from the groups of monomers A and B are together present in an amount of at least 95 wt.-% based on the total weight of the cross-linked polyester.

34. The method of claim 32, wherein the units in the crosslinked polyester derived from the groups of monomers A and B are together present in an amount of at least 99 wt.-% based on the total weight of the cross-linked polyester.

35. The method of claim 32, wherein the unsaturated polyester chains are inter-molecularly cross-linked via the double bonds contained therein.

36. The method of claim 32, wherein cross-linking is achieved by inter-molecularly reacting the unsaturated polyester chains at a temperature from 150° C. to 250° C. for at least 20 h, optionally in the presence of a peroxide.
